(19) United States
(12) Patent Application Publication
(10) Pub. No.: US 2025/0077273 A1
(43) Pub. Date: Mar. 6, 2025

(54) System and Method for Interaction Resiliency in the Metaverse

(71) Applicant: Bank of America Corporation, Charlotte, NC (US)

(72) Inventors: Ngoc Tran, Charlotte, NC (US); Maneesh Kumar Sethia, Hyderabad (IN); Sandeep Kumar Chauhan, Hyderabad (IN); Saurabh Arora, Gurugram (IN)

(21) Appl. No.: 18/459,146

(22) Filed: Aug. 31, 2023

(51) Int. Cl. G06F 9/48; H04L 9/40

(52) U.S. Cl. CPC G06F 9/4881; H04L 63/0876

(57) ABSTRACT

A metaverse server comprises an edge node processor and a remote node processor. The edge node processor receives a request to perform a task comprising a first set of one or more operations and a second set of one or more operations from a client device associated with a metaverse user, executes the first set of one or more operations, sends a first notification indicating that the task is being performed to the client device, and forwards the second set of one or more operations to the remote node processor. The remote node processor receives the second set of one or more operations, executes each of the second set of one or more operations when conditions for executing the operation are satisfied, and sends a second notification indicating that the task has been completed to the client device upon completion of the second set of one or more operations.

### TECHNICAL FIELD

The present disclosure relates generally to network communication, and more specifically to a system and method for interaction resiliency in the metaverse.

### BACKGROUND

Institutions across different categories of business lines may be adopting a metaverse ecosystem. As a number of customers using metaverse platforms increases, loads to the metaverse server may increase. It is challenging to make a metaverse server that is capable of serving multiple users simultaneously without any downtime. It is further challenging to handle interactions with users on a metaverse server notwithstanding issues the metaverse server is experiencing.

### SUMMARY

The system and methods implemented by the system as disclosed in the present disclosure provide technical solutions to the technical problems discussed above by handling requests from metaverse users in a resilient manner by a metaverse server in a metaverse environment. The disclosed system and methods provide several practical applications and technical advantages.

For example, the disclosed system and methods provide the practical application of handling requests from metaverse users in an interaction resilient manner by a metaverse server in the metaverse environment. An interaction resiliency of a system may indicate that the system is capable of serving multiple users simultaneously without significant downtime and further capable of handling interactions with users notwithstanding issues the metaverse server is experiencing. Institutions across different categories of business lines may be adopting a metaverse ecosystem. As a number of customers using metaverse platform increases, loads to the metaverse server may increase. Thus, the interaction resiliency of the metaverse server may become important. An application object in a metaverse environment may be heavy because the application object needs to provide a metaverse experience to the users as well as perform back-end processes. A single application instance may not be able to maintain the interaction resiliency while serving a large number of users simultaneously. The system and methods disclosed herein may split operations required to fulfill a task requested by a user into two sets. A first set of operations may be executed by an edge node processor of the metaverse server, and a second set of operations may be executed by a remote node processor of the metaverse server. A metaverse user should be able to submit a request for a task asynchronously. The metaverse server should be able to perform the task in a manner such that the metaverse server may complete different portions of the task.

A metaverse server may comprise an edge node processor and a remote node processor. The edge node processor may be configured to receive a request of a metaverse user to log into a metaverse environment managed by the metaverse server from a client device associated with a metaverse user. The edge node processor may retrieve user information associated with the metaverse user from a database communicatively connected to the remote node processor to a cache communicatively connected to the edge node processor. The user information at the cache may be updated in an eventually-consistent manner. A change to the user information at the database associated with the remote node processor may not be immediately reflected to the user information at the cache but reflected when the edge node processor performs a cache synchronization. The edge node processor may authenticate the metaverse user based on the user information. The edge node processor may send a response indicating a successful authentication to the client device.

The edge node processor of the metaverse server may be configured to receive a request to perform a task from the client device. The task may comprise a first set of one or more operations and a second set of one or more operations. The first set of one or more operations may be executed by the edge node processor. The second set of one or more operations may need to be executed by the remote node processor. The edge node processor may be configured to execute the first set of one or more operations. In particular embodiments, the first set of one or more operations may comprise presenting at least a part of the user information at the cache to the metaverse user in the metaverse environment. In particular embodiments, the first set of one or more operations may comprise refreshing a metaverse environment the metaverse user is accessing. The refreshing of the metaverse environment may comprise updating a visual representation of a part of the metaverse environment or updating audio effects in the metaverse environment. The edge node processor may be configured to send a first notification to the client device indicating that the task is being performed. The edge node processor may be configured to forward to the remote node processor the second set of one or more operations.

The remote node processor of the metaverse server may be configured to receive the second set of one or more operations from the edge node processor. In particular embodiments, the second set of one or more operations may comprise an operation involving an interaction with an external computing device. In particular embodiments, the second set of one or more operations may comprise an operation permanently changing data associated with the metaverse user. In particular embodiments, the second set of one or more operations may comprise a particular operation that needs to wait for longer than a pre-determined amount of time before conditions for executing the particular operation are satisfied. In particular embodiments, the second set of one or more operations may comprise an operation that takes more than a pre-determined amount of time to execute. The remote node processor may be configured to execute each of the second set of one or more operations when conditions for executing the operation are satisfied. To execute each of the second set of one or more operations, the remote node processor may be configured to store a record associated with the operation to a waiting queue until the conditions for executing the operation are satisfied. The remote node processor may be configured to determine that the conditions for executing the operation are satisfied. The remote node processor may be configured to execute the operation in response to the determination. The remote node processor may be configured to remove the record associated with the operation from the waiting queue. The remote node processor may be configured to send a second notification indicating that the task has been completed to the client device upon completion of the second set of one or more operations.

In particular embodiments, the metaverse server may further comprise a plurality of additional edge node processors. Each of the plurality of additional edge node processors may be assigned to one or more active metaverse users. In particular embodiments, the metaverse server may further comprise a plurality of additional remote node processors. Each of the plurality of additional remote node processors may be assigned to one or more active metaverse users.

Thus, the disclosed system and method generally improve the technology related to performing interactions in the metaverse environment. The disclosed system and method distributes loads into multiple processors in a distributed manner so that a potential processing bottleneck may be avoided in responding to the metaverse users. Furthermore, the disclosed system and method provide interaction resiliency by employing queuing and retrying at the remote node processor, which may reduce or eliminate retransmissions of the task request from the metaverse user and complete tasks with reduced delay.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a system, in accordance with certain aspects of the present disclosure;

FIG. 2 is a block diagram of an embodiment of the metaverse server used by the system of FIG. 1;

FIG. 3 illustrates a flowchart of an example method for performing a task in a metaverse environment, in accordance with one or more embodiments of the present disclosure.

### DETAILED DESCRIPTION

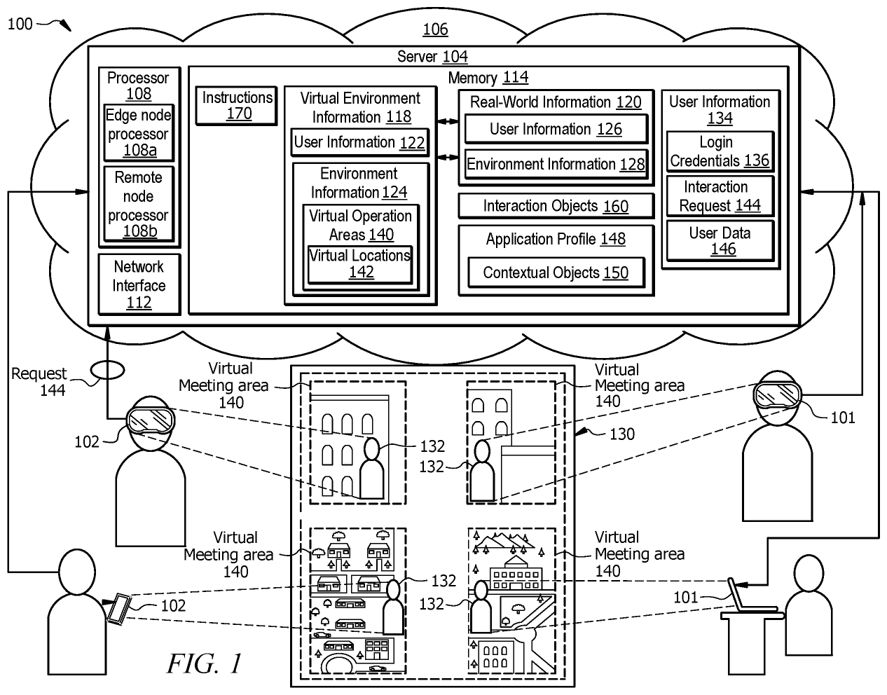

As described above, previous technologies fail to provide an interaction resiliency of a metaverse server in the metaverse environment. This disclosure presents a system and methods for handling requests from metaverse users in a resilient manner by a metaverse server in a metaverse environment by referring to FIGS. 1 through 3.

### Metaverse System Overview

FIG. 1 illustrates one embodiment of a system 100 that is configured to provide resilient interactions within a metaverse environment 130 in a network 106. The metaverse environment is a two-dimensional (2D) or three-dimensional (3D) digital space that uses virtual reality (VR), augmented reality (AR), and other advanced internet and computer technology to allow users to have realistic personal and business experiences online. In one embodiment, the system 100 comprises a server 104, one or more entity devices 101, one or more client devices 102, and a network 106. The system 100 may be communicatively coupled to the network 106 and may be operable to transmit data between each entity device 101, each client device 102 and the server 104 through the network 106. Network 106 enables the communication between components of the system 100. Server 104 comprises processors 108 in signal communication with a memory 114.

In some embodiments, the system 100 may be implemented by the server 104 to provide resilient interactions in a metaverse environment 130. The server 104 may receive an interaction request 144 for an application service from the client device 102. The application service may comprise one or more operations. A first set of one or more operations may be executed by an edge node processor 108a and a second set of one or more operations may be executed by a remote node processor 108b in a distributed manner. The server 104 may retrieve user information 134 stored in the memory 114 upon receiving a first interaction request 144. The server 104 may authenticate the user based on login credentials 136 within the retrieved user information 134. The server 104 may generate a metaverse meeting area 140 with an entity avatar 132 associated with the entity device 101 while authenticating the user. The server 104 may present interaction objects 160 associated with the client device 102 and the entity avatar 132 in the metaverse meeting area 140 on a graphical user interface (GUI) of the client device 102.

### System Components

### Network

The network 106 may include any interconnecting system capable of transmitting audio, video, signals, data, messages, or any combination of the preceding. The network 106 may include all or a portion of a local area network, a metropolitan area network, a wide area network, an overlay network, a software-defined network a virtual private network, a packet data network (e.g., the Internet), a mobile telephone network (e.g., cellular networks, such as 4G or 5G), a Plain Old Telephone network, a wireless data network (e.g., Wi-Fi, WiGig, WiMax, etc.), a Long Term Evolution network, a Universal Mobile Telecommunications System network, a peer-to-peer network, a Bluetooth network, a Near Field Communication network, a Zigbee network, and/or any other suitable network. The network 106 may be configured to support any suitable type of communication protocol as would be appreciated by one of ordinary skill in the art.

### Client Devices

A client device 102 is a hardware device that is generally configured to provide hardware and software resources to a user. Examples of a client device 102 include, but are not limited to, a VR device, an AR device, a laptop, a computer, a smartphone, a tablet, a smart device, an Internet-of-Things (IoT) device, or any other suitable type of device. The client device 102 may comprise a graphical user interface (e.g., a display), a touchscreen, a touchpad, keys, buttons, a mouse, or any other suitable type of hardware that allows a user to view data and/or to provide inputs into the client device 102.

Each client device 102 is configured to display a 2D or 3D representation of a metaverse environment 130 to a user. Each client device 102 is further configured to allow a user to send a request for the client device 102 to access and navigate through virtual meeting areas 140 in the metaverse environment 130 to interact with the server 104. As another example, a user may use a client device 102 to send an interaction request 144 to perform a task to the server 104. Example processes are described in more detail below.

Each client device 102 is configured to display a 2D or 3D representation of a metaverse environment 130 to a user. Examples of a metaverse environment 130 include, but are not limited to, a graphical or virtual representation of a metaverse, a map, a city, a building interior, a landscape, a fictional location, an alternate reality, or any other suitable type of location or environment. A metaverse environment 130 may be configured to use realistic or non-realistic physics for the motion of objects within the metaverse environment 130. Within the metaverse environment 130, each user may be associated with a client device 102 and an avatar 132. An avatar 132 is a graphical representation of the client device 102 and the user within the metaverse environment 130. Examples of the avatars 132 include, but are not limited to, a person, an animal, or an object. In some embodiments, the features and characteristics of the avatar 132 may be customizable and user defined. For example, the size, shape, color, attire, accessories, or any other suitable type of appearance features may be specified by a user. By using the avatar 132, a user or the client device 102 can move within the metaverse environment 130 to interact with an entity associated with the server 104 or other avatars 132 and objects within the metaverse environment 130.

### Server

The server 104 comprises one or more hardware devices that is generally configured to provide services and software and/or hardware resources to client devices 102. The server 104 is generally a server, or any other device configured to process data and communicate with client devices 102 via the network 106. In particular embodiments, the server 104 may be implemented in the cloud or may be organized in either a centralized or distributed manner.

The processors 108 are hardware devices that comprises a plurality of processors operably coupled to the memory 114. The processors 108 may comprise one or more edge node processors 108a and one or more remote node processors 108b. The processors 108 are any electronic circuitry including, but not limited to, state machines, one or more central processing unit (CPU) chips, logic units, cores (e.g., a multi-core processor), field-programmable gate array (FPGAs), application-specific integrated circuits (ASICs), or digital signal processors (DSPs). The processors 108 may be a programmable logic device, a microcontroller, a microprocessor, or any suitable combination of the preceding. The processors 108 are communicatively coupled to and in signal communication with the memory 114 and the network interface 112. The one or more processors are configured to process data and may be implemented in hardware or software. For example, the processors 108 may be 8-bit, 16-bit, 32-bit, 64-bit, or of any other suitable architecture. The processors 108 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The plurality of processors are configured to implement various instructions. The processors 108 may be a special-purpose computer designed to implement the functions disclosed herein.

The memory 114 stores any of the information described above with respect to FIGS. 1 through 3 along with any other data, instructions, logic, rules, or code operable to implement the function(s) described herein when executed by the processors 108. In particular embodiments, the memory 114 may be a non-transitory computer readable medium. The memory 114 comprises one or more disks, tape drives, or solid-state drives, and may be used as an over-flow data storage device, to store programs when such programs are selected for execution, and to store instructions 170 and data that are read during program execution. The memory 114 may be volatile or non-volatile and may comprise a read-only memory (ROM), random-access memory (RAM), ternary content-addressable memory (TCAM), dynamic random-access memory (DRAM), and static random-access memory (SRAM).

The memory 114 is operable to store user information 134, application profile 148 including contextual objects 150, virtual environment information 118, real-world information 120, avatars 132, virtual meeting areas 140 including corresponding virtual locations 142, metaverse environment 130, and/or any other data or instructions 170. A user information 134 includes login credentials 136, interaction requests 144, and user data 146. A plurality of user information 134 may be stored by the processors 108 in the memory 114. The login credentials 136 are associated with a client device 102 and are configured to register the client device 102 to interact with systems or platforms associated with an entity at a plurality of physical locations in a real-world environment. The login credentials 136 are configured to provide authentication for the client device 102 to communicate with an entity in a real-world environment and for an avatar 132 associated with the client device 102 to navigate in a metaverse environment 130.

The virtual environment information 118 comprises user information 122 and environment information 124. The user information 122 generally comprises information that is associated with any user profiles associated with user accounts that can be used within a metaverse environment 130. The environment information 124 include data of virtual meeting areas 140a-140d and corresponding virtual locations 142. For example, user information 122 may comprise user profile information, online account information, digital assets information, or any other suitable type of information that is associated with a user within a metaverse environment 130. The environment information 124 generally comprises information about the appearance of a metaverse environment 130. For example, the environment information 124 may comprise information associated with objects, landmarks, buildings, structures, avatars 132, virtual meeting areas 140, or any other suitable type of element that is present within a metaverse environment 130. In some embodiments, the environment information 124 may be used to create a representation of a metaverse environment 130 for users. In this case, a metaverse environment 130 may be implemented using any suitable type of software framework or engine.

Examples of a metaverse environment 130 include, but are not limited to, a graphical or virtual representation of a metaverse, a map, a city, a building interior, a landscape, a fictional location, an alternate reality, or any other suitable type of location or environment. A metaverse environment 130 may be configured to use realistic or non-realistic physics for the motion of objects within the metaverse environment 130.

The real-world information 120 comprises user information 126 and environment information 128. The user information 126 generally comprises information that is associated with user profiles and user accounts that can be used within the real world. For example, user information 126 may comprise user profile information, account information, or any other suitable type of information that is associated with a user within a real-world environment. The environment information 128 generally comprises information that is associated with an entity within the real-world that the user is a member of or is associated with. For example, the environment information 128 may comprise physical addresses, GPS based locations, phone numbers, email addresses, contact names, or any other suitable type of information that is associated with an entity. Since the server 104 has access to both the virtual environment information 118 and the real-world information 120, the server 104 may link the virtual environment information 118 and the real-world information 120 together for a user such that changes to the virtual environment information 118 affect or propagate to the real-world information 120 and vice-versa. The server 104 may be configured to store one or more maps that translate or convert different types of interactions between the real-world environment and the metaverse environment 130 and vice-versa.

The network interface 112 is a hardware device that is configured to enable wired and/or wireless communications. The network interface 112 is configured to communicate data between client devices 102 and other devices, systems, or domains. For example, the network interface 112 may comprise an NFC interface, a Bluetooth interface, a Zigbee interface, a Z-wave interface, a radio-frequency identification (RFID) interface, a WIFI interface, a LAN interface, a WAN interface, a PAN interface, a modem, a switch, or a router. The processors 108 are configured to send and receive data using the network interface 112. The network interface 112 may be configured to use any suitable type of communication protocol as would be appreciated by one of ordinary skill in the art.

### Initiating Interactions in a Metaverse Environment

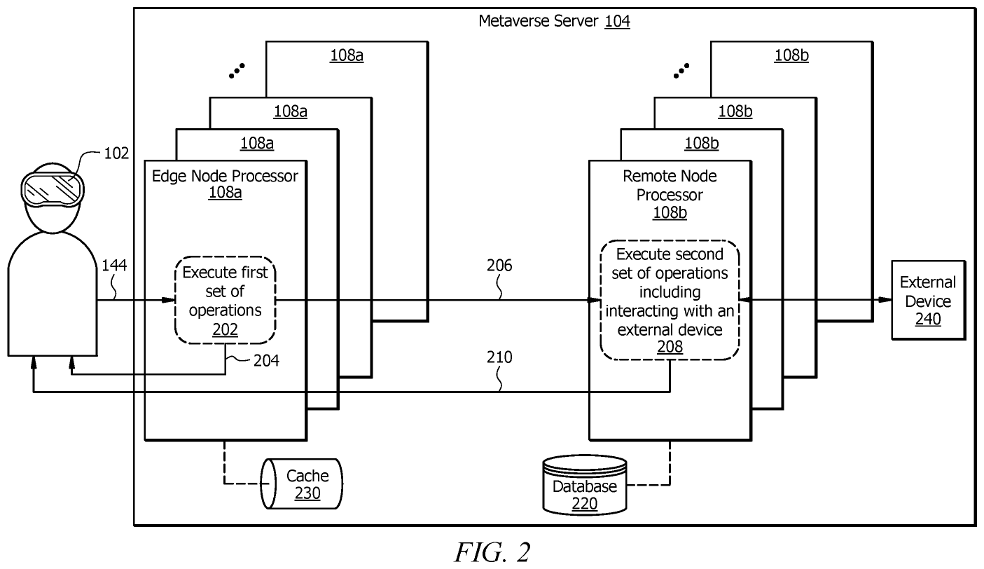

FIG. 2 is a block diagram of an embodiment of the metaverse server used by the system of FIG. 1. A metaverse server 104 may comprise one or more edge node processors 108a and one or more remote node processors 108b. The processors 108 in FIG. 1 may comprise the one or more edge node processors 108a and the one or more remote node processors 108b. The one or more edge node processors 108a may be communicatively connected to a cache 230. The one or more remote node processors 108b may be communicatively connected to a database 220. The cache 230 and the database 220 may be parts of the memory 114.

In particular embodiments, an edge node processor 108a may be configured to receive an interaction request 144 of a metaverse user to log into a metaverse environment 130 managed by the metaverse server 104 from a client device 102 associated with a metaverse user. The edge node processor 108a may retrieve user information 134 associated with the metaverse user from the database 220 communicatively connected to the remote node processors 108b to a cache 230 communicatively connected to the edge node processor 108a. The edge node processor 108a may authenticate the metaverse user based on login credentials 136 within the retrieved user information 134. The edge node processor 108a may generate a metaverse meeting area 140 with an entity avatar 132 associated with the entity device 101 while authenticating the metaverse user. The edge node processor 108a may send a response indicating a successful authentication to the client device 102 associated with the metaverse user. The edge node processor 108a may also present interaction objects 160 in the metaverse meeting area 140 on a graphical user interface (GUI) of the client device 102.

The retrieved user information at the cache 230 may be updated in an eventually-consistent manner. A change to the user information 134 at the database 220 communicatively connected with the remote node processor 108b may not be immediately reflected to the user information at the cache 230. The change of the user information 134 may be reflected to the cache 230 when the edge node processor 108a performs a cache synchronization.

### Executing Operations in a Distributed Manner

In particular embodiments, the metaverse user may want the metaverse server 104 to perform a task comprising a plurality of operations. Based on input from the metaverse user indicating to send an interaction request 144 to perform the task, the client device 102 associated with the metaverse user may send the interaction request 144. The edge node processor 108a of the metaverse server 104 may be configured to receive the interaction request 144 to perform a task from the client device 102. The task may comprise a first set of one or more operations and a second set of one or more operations. The first set of one or more operations may be executed by the edge node processor 108a. The second set of one or more operations may need to be executed by the remote node processor 108b. The edge node processor 108a may be configured to identify the first set of one or more operations and the second set of one or more operations among operations to be performed to complete the task. The edge node processor 108a may be configured to execute the first set of one or more operations. The edge node processor 108a may be configured to forward the second set of one or more operations to the remote node processor 108b. The edge node processor 108a may be configured to execute the second set of one or more operations.

In an example illustrated in FIG. 2, the client device 102 associated with the metaverse user may send an interaction request 144 for a task to the metaverse server 104. Upon receiving the interaction request 144, the edge node processor 108a may identify a plurality of operations to be executed to complete the task. The edge node processor 108a may determine a first set of one or more operations to be executed by the edge node processor 108a among the plurality of operations. The edge node processor 108a may also determine a second set of one or more operations to be executed by the remote node processor 108b among the plurality of operations.

The edge node processor 108a may execute the first set of one or more operations at operation 202. As an example and not by way of limitation, the first set of one or more operations may comprise presenting at least a part of the user information at the cache 230 to the metaverse user in the metaverse environment 130. As another example and not by way of limitation, the first set of one or more operations may comprise refreshing the metaverse environment 130 that the metaverse user is accessing. The refreshing of the metaverse environment 130 may comprise updating a visual representation of a part of the metaverse environment 130 or updating audio effects in the metaverse environment 130. In particular embodiments, the refreshing of the metaverse environment 130 may comprise updating the interaction objects 160 associated with the client device presented on the GUI of the client device 102. In particular embodiments, the refreshing of the metaverse environment 130 may comprise updating the entity avatar 132 presented on the GUI of the client device 102.

The edge node processor 108a may be configured to forward the second set of one or more operations to the remote node processor 108b at operation 206. In particular embodiments, the remote node processor 108b may be determined among one or more available remote node processors 108b in the metaverse server 104 when the metaverse user logs into the metaverse server 104. In particular embodiments, a module within the metaverse server 104 may select a remote node processor 108b to execute the second set of one or more operations among available remote node processors in the metaverse server 104. In particular embodiments, the module may be a load-management module. The edge node processor 108a may forward the second set of one or more operations to the instantly selected remote node processor 108b. In such a case, a number of different remote node processors 108b may perform operations for the metaverse user in a single login session.

The edge node processor 108a may be configured to send a first notification 204 to the client device 102 indicating that the task is being performed. Upon receiving the first notification 204, the client device 102 may present an indication to the metaverse user indicating that the interaction request 144 has been successfully submitted to the metaverse server 104 and the interaction request 144 is being processed by the metaverse server 104. Based on the indication, the metaverse user may not need to submit duplicated interaction requests 144 for the same task even when a second notification 210 indicating a task completion is being delayed.

The remote node processor 108b of the metaverse server 104 may be configured to receive the second set of one or more operations from the edge node processor 108a at operation 206. In particular embodiments, the remote node processor 108b may be associated with the metaverse user when the metaverse user logs into the metaverse server 104. In particular embodiments, the remote node processor 108b may be instantly selected by a module immediately before the edge node processor 108a send the second set of one or more operations. At operation 208, the remote node processor 108b may execute the second set of one or more operations. In particular embodiments, the second set of one or more operations may comprise an operation involving an interaction with an external computing device 240. As an example and not by way of limitation, the second set of one or more operations may comprise sending data to an external computing device 240. As another example and not by way of limitation, the second set of one or more operations may comprise exchanging data with an external computing device 240. In particular embodiments, the second set of one or more operations may comprise an operation permanently changing user data 146 associated with the metaverse user. As an example and not by way of limitation, the second set of one or more operations may comprise updating user contact information such as a mailing address, a phone number, or an email address. As another example and not by way of limitation, the second set of one or more operations may comprise updating user data 146 based on the data exchange with the external computing device 240. In particular embodiments, the second set of one or more operations may comprise a particular operation that needs to wait for longer than a pre-determined amount of time before conditions for executing the particular operation are satisfied. As an example and not by way of limitation, the second set of one or more operations may comprise sending a message to an external computing device 240 at a pre-determined time instance. The remote node processor 108b may set a timer to the pre-determined time instance and send the message to the external computing device 240 when the timer expires. In particular embodiments, the second set of one or more operations may comprise an operation that takes more than a pre-determined amount of time to execute. As an example and not by way of limitation, the second set of one or more operations may comprise performing extensive computations that may take more than several seconds. Also, the extensive computations may require the remote node processor 108b to wait until required computing resources become available. As another example and not by way of limitation, the second set of one or more operations may comprise exchanging a series of messages with one or more external computing devices 240, which may take more than several seconds. Upon completing the second set of one or more operations, the remote node processor 108b may be configured to send a second notification 210 indicating that the task has been completed to the client device 102.

### Executing Operations in a Resilient Manner

In particular embodiments, each of the second set of one or more operations may be associated with conditions for executing the operation. As an example and not by way of limitation, an operation in the second set of one or more operations may be executed on or after a pre-determined time. As another example and not by way of limitation, an operation in the second set of one or more operations may be executed when a pre-determined computing resources are available. As yet another example and not by way of limitation, an operation in the second set of one or more operations may be executed when a network connection is established with an external computing device 240. The remote node processor 108b may be configured to execute each of the second set of one or more operations when conditions for executing the operation are satisfied. To execute each of the second set of one or more operations, the remote node processor 108b may be configured to determine whether conditions for executing the operation are met. If the conditions for executing the operation are not satisfied, the remote node processor 108b may store a record associated with the operation to a waiting queue until the conditions for executing the operation are satisfied. In particular embodiments, the remote node processor 108b may set a triggering event for each record associated with an operation in the waiting queue. As an example and not by way of limitation, the remote node processor 108b may set a timer to a time instance when the operation is to be executed on or after the time instance. When the timer expires, the remote node processor 108b may determine that the conditions for executing the operation are satisfied. The remote node processor 108b may be configured to execute the operation in response to the determination. As another example and not by way of limitation, the remote node processor 108b may setup an event-driven notification for a network connection establishment with an external computing device 240 when the operation is to be executed when the network connection is established. As yet another example and not by way of limitation, the remote node processor 108b may set a random timer associated with each record in the waiting queue. When the timer associated with a record expires, the remote node processor 108b may determine whether conditions for execution an operation corresponding to the record are satisfied. If not, the remote node processor 108b may set another random timer associated with the record. If the conditions are satisfied, the remote node processor 108b may execute the operation corresponding to the record. The remote node processor 108b may be configured to remove the record associated with the operation from the waiting queue after successfully executing the operation. When all of the second set of one or more operations are successfully executed, the remote node processor 108b may send the second notification 210 indicating that the task has been completed to the client device 102 associated with the metaverse user.

In particular embodiments, the metaverse server 104 may further comprise a plurality of additional edge node processors 108a. Each of the plurality of additional edge node processors 108a may be assigned to one or more active metaverse users. In particular embodiments, the metaverse server 104 may further comprise a plurality of additional remote node processors 108b. Each of the plurality of additional remote node processors 108b may be assigned to one or more active metaverse users.

### Example Method

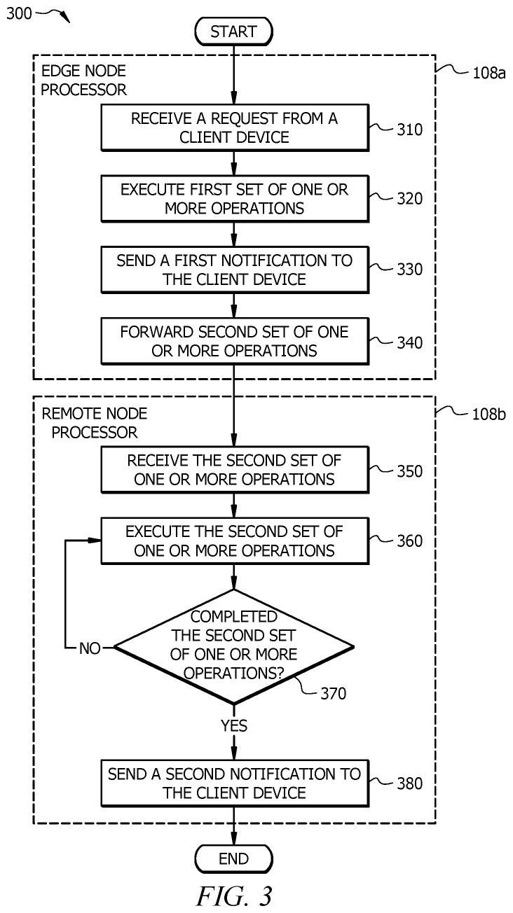

FIG. 3 illustrates a flowchart of an example method 300 for performing a task in a metaverse environment, in accordance with one or more embodiments of the present disclosure. Method 300 may be performed by the metaverse server 104 shown in FIG. 2. The metaverse server 104 may comprise an edge node processor 108a and a remote node processor 108b.

At operation 310, the edge node processor 108a may receive a request to perform a task from a client device associated with a metaverse user. The task may comprise a first set of one or more operations that are executed by the edge node processor 108a and a second set of one or more operations that need to be executed by the remote node processor 108b. Upon receiving the request, the edge node processor 108a may identify a plurality of operations to be executed to complete the task. The edge node processor 108a may determine a first set of one or more operations to be executed by the edge node processor 108a among the plurality of operations. The edge node processor 108a may also determine a second set of one or more operations to be executed by the remote node processor 108b among the plurality of operations. At operation 320, the edge node processor 108a may execute the first set of one or more operations. In particular embodiments, the first set of one or more operations may comprise presenting at least a part of the user information at the cache 230 to the metaverse user in the metaverse environment. In particular embodiments, the first set of one or more operations may comprise refreshing the metaverse environment that the metaverse user is accessing. The refreshing of the metaverse environment may comprise updating a visual representation of a part of the metaverse environment or updating audio effects in the metaverse environment. At operation 330, the edge node processor 108a may send a first notification to the client device associated with the metaverse user indicating that the task is being performed. Based on the first notification, the metaverse user may not need to submit duplicated requests for the same task even when a second notification indicating a task completion is being delayed. At operation 340, the edge node processor 108a may forward the second set of one or more operations to the remote node processor 108b. Because operations 320, 330 and 340 are not depending on each other, the operations 320, 330, and 340 may occur in any suitable order. At operation 350, the remote node processor 108b may receive the second set of one or more operations from the edge node processor 108a. At operation 360, the remote node processor 108b may execute each of the second set of one or more operations when conditions for executing the operation are satisfied. To execute each of the second set of one or more operations, the remote node processor 108b may determine whether conditions for executing the operation are met. If the conditions for executing the operation are not satisfied, the remote node processor 108b may store a record associated with the operation to a waiting queue until the conditions for executing the operation are satisfied. If the conditions for executing the operation are satisfied, the remote node processor 108b may execute the operation. At operation 370, the remote node processor 108b may determine whether the second set of one or more operations has been completed. If any of the second set of one or more operations is yet to be executed, the remote node processor 108b may go to operation 360. If the second set of one or more operations has been completed. the remote node processor 108b may proceed to operation 380, where the remote node processor 108b may send a second notification to the client device indicating that the task has been completed.

1. A metaverse server comprising:
an edge node processor; and
a remote node processor,
wherein the edge node processor is configured to:
receive, from a client device associated with a metaverse user, a request to perform a task comprising a first set of one or more operations that are executed by the edge node processor and a second set of one or more operations that need to be executed by the remote node processor;
execute the first set of one or more operations;
send, to the client device, a first notification indicating that the task is being performed; and
forward the second set of one or more operations to the remote node processor; and
wherein the remote node processor is configured to:
receive, from the edge node processor, the second set of one or more operations;
execute each of the second set of one or more operations when conditions for executing the operation are satisfied; and
send, upon completion of the second set of one or more operations, to the client device, a second notification indicating that the task has been completed.

2. The metaverse server of claim 1, wherein the edge node processor is further configured to:
receive, from the client device, a request of the metaverse user to log into a metaverse environment managed by the metaverse server;
retrieve, from a database communicatively connected to the remote node processor, user information associated with the metaverse user to a cache communicatively connected to the edge node processor;
authenticate the metaverse user based on the user information; and
send, to the client device, a response indicating a successful authentication.

3. The metaverse server of claim 2, wherein the user information at the cache is updated in an eventually-consistent manner, in which a change to the user information at the database associated with the remote node processor is not immediately reflected to the user information at the cache but reflected when the edge node processor performs a cache synchronization.

4. The metaverse server of claim 2, wherein the first set of one or more operations comprises presenting at least a part of the user information at the cache to the metaverse user in the metaverse environment.

5. The metaverse server of claim 1, wherein the second set of one or more operations comprises an operation involving an interaction with an external computing device.

6. The metaverse server of claim 1, wherein executing each of the second set of one or more operations comprises:
storing a record associated with the operation to a waiting queue until the conditions for executing the operation are satisfied;
determining that the conditions for executing the operation are satisfied;
executing, in response to the determination, the operation; and
removing the record associated with the operation from the waiting queue.

7. The metaverse server of claim 1, further comprising:
a plurality of additional edge node processors, wherein each of the plurality of additional edge node processors is assigned to one or more active metaverse users; and
a plurality of additional remote node processors, wherein each of the plurality of additional remote node processors is assigned to one or more active metaverse users.

8. A method comprising:
receiving, by an edge node processor of a metaverse server, from a client device associated with a metaverse user, a request to perform a task comprising a first set of one or more operations that are executed by the edge node processor and a second set of one or more operations that need to be executed by a remote node processor of the metaverse server;
executing, by the edge node processor, the first set of one or more operations;
sending, by the edge node processor, to the client device, a first notification indicating that the task is being performed;
forwarding, by the edge node processor, the second set of one or more operations to the remote node processor; and
receiving, by the remote node processor, from the edge node processor, the second set of one or more operations;
executing, by the remote node processor, each of the second set of one or more operations when conditions for executing the operation are satisfied; and
sending, by the remote node processor, upon completion of the second set of one or more operations, to the client device, a second notification indicating that the task has been completed.

9. The method of claim 8, further comprising:
receiving, by the edge node processor, from the client device, a request of the metaverse user to log into a metaverse environment managed by the metaverse server;
retrieving, by the edge node processor, from a database communicatively connected to the remote node processor, user information associated with the metaverse user to a cache communicatively connected to the edge node processor;
authenticating, by the edge node processor, the metaverse user based on the user information; and
sending, by the edge node processor, to the client device, a response indicating a successful authentication.

10. The method of claim 9, wherein the user information at the cache is updated in an eventually-consistent manner, in which a change to the user information at the database associated with the remote node processor is not immediately reflected to the user information at the cache but reflected when the edge node processor performs a cache synchronization.

11. The method of claim 9, wherein the first set of one or more operations comprises presenting at least a part of the user information at the cache to the metaverse user in the metaverse environment.

12. The method of claim 8, wherein the second set of one or more operations comprises an operation involving an interaction with an external computing device.

13. The method of claim 8, wherein executing each of the second set of one or more operations comprises:
storing a record associated with the operation to a waiting queue until the conditions for executing the operation are satisfied;
determining that the conditions for executing the operation are satisfied;
executing, in response to the determination, the operation; and
removing the record associated with the operation from the waiting queue.

14. The method of claim 8, wherein the metaverse server further comprises a plurality of additional edge node processors, wherein each of the plurality of additional edge node processors is assigned to one or more active metaverse users, and wherein the metaverse server further comprises a plurality of additional remote node processors, wherein each of the plurality of additional remote node processors is assigned to one or more active metaverse users.

15. A non-transitory computer-readable medium storing instructions that when executed by one or more processors cause the one or more processors to:
receive, by an edge node processor of a metaverse server, from a client device associated with a metaverse user, a request to perform a task comprising a first set of one or more operations that are executed by the edge node processor and a second set of one or more operations that need to be executed by a remote node processor of the metaverse server;
execute, by the edge node processor, the first set of one or more operations;
send, by the edge node processor, to the client device, a first notification indicating that the task is being performed; and
forward, by the edge node processor, the second set of one or more operations to the remote node processor;
receive, by the remote node processor, from the edge node processor, the second set of one or more operations;
execute, by the remote node processor, each of the second set of one or more operations when conditions for executing the operation are satisfied; and
send, by the remote node processor, upon completion of the second set of one or more operations, to the client device, a second notification indicating that the task has been completed.

16. The non-transitory computer-readable medium of claim 15, wherein the instructions further cause the one or more processors to:
receive, by the edge node processor, from the client device, a request of the metaverse user to log into a metaverse environment managed by the metaverse server;
retrieve, by the edge node processor, from a database communicatively connected to the remote node processor, user information associated with the metaverse user to a cache communicatively connected to the edge node processor;
authenticate, by the edge node processor, the metaverse user based on the user information; and
send, by the edge node processor, to the client device, a response indicating a successful authentication.

17. The non-transitory computer-readable medium of claim 16, wherein the user information at the cache is updated in an eventually-consistent manner, in which a change to the user information at the database associated with the remote node processor is not immediately reflected to the user information at the cache but reflected when the edge node processor performs a cache synchronization.

18. The non-transitory computer-readable medium of claim 16, wherein the first set of one or more operations comprises presenting at least a part of the user information at the cache to the metaverse user in the metaverse environment.

19. The non-transitory computer-readable medium of claim 15, wherein the second set of one or more operations comprises an operation involving an interaction with an external computing device.

20. The non-transitory computer-readable medium of claim 15, wherein executing each of the second set of one or more operations comprises:
storing a record associated with the operation to a waiting queue until the conditions for executing the operation are satisfied;
determining that the conditions for executing the operation are satisfied;
executing in response to the determination, the operation; and
removing the record associated with the operation from the waiting queue.
